(19) United States
(12) Patent Application Publication
(10) Pub. No.: US 2007/0065784 A1
(43) Pub. Date: Mar. 22, 2007

(54) Teaching method for riding a bicycle

(76) Inventor: Harvey A. Nix, Birmingham, AL (US)

Correspondence Address: BUSH INTELLECTUAL PROPERTY LAW GROUP, LLC, P.O. BOX 381146, BIRMINGHAM, AL, 35238, US

(21) Appl. No.: 11/222,563

(22) Filed: Sep. 9, 2005

(51) Int. Cl. G09B 19/16

(52) U.S. Cl. 434/61

(57) ABSTRACT

A method for teaching a learner how to ride a bicycle by providing a bicycle with an empty pedal crank housing, where the bicycle permits the learner's feet to touch the ground when the learner sits on the bicycle. The learner first moves the bicycle forward by walking, then by pushing the bicycle forward with the feet and coasting, then by coasting and turning the bicycle, and, after installing a pedal crank drive assembly and drive chain, pushing the bicycle forward with the feet and then pedaling the pedal crank drive assembly to drive the bicycle forward. The method can be implemented by providing a kit having a bicycle with an empty pedal crank housing, caps for the empty pedal crank housing, a pedal crank drive assembly, a drive chain, instructions for assembly, and instructions for teaching the method of the present invention.

### BACKGROUND OF THE INVENTION

1. Field of the Invention

The present invention relates to methods of teaching individuals to operate a bicycle and, more particularly, to teaching individuals to learn to balance a bicycle by moving the bicycle forward with their feet while coasting and turning.

2. Technical Background

The key to teaching a person to ride a bicycle is to provide a method for the person to learn how to balance the bicycle as the bicycle is moving forward and while it is being turned. A common approach is for one person to steady the bicycle and prevent it from falling over while the learner tries to peddle the bicycle in a forward direction. With this method most learners fear the prospect of falling off the bicycle or going too fast to maintain control. The psychological impact of this fear can produce a lack of concentration and a prolongation of the learning process. This method is also associated with a significant risk of bodily injury.

A popular and safer approach has been the use of training wheels. The problem with training wheels is that the learner does not acquire the necessary balancing responses which are required when the training wheels are removed. This is because the learner usually becomes dependent on the training wheels to provide balancing. When the training wheels are removed, the fear of falling or losing control returns, again interfering with the learning process.

Another approach has been to have a learner respond to left and right tilting of the bicycle while the bicycle is not moving forward. Although this method may teach some balance skill on a non-moving bicycle, it is insufficient to eliminate the fear of attempting to balance a moving bicycle.

What is needed is a method that will allow a learner to balance a bicycle without any apprehension or fear while the bicycle is moving and being turned.

### SUMMARY OF THE INVENTION

The present invention is a method for teaching an individual how to ride a bicycle by learning to balance the bicycle as it moves and turns, without the learner having any fear of falling while learning to balance the moving bicycle. The method includes providing a bicycle with a seat elevation that allows the user's feet to touch the ground, in order to control the vertical orientation of the bicycle. The learner is instructed to sit on the bicycle seat, put his or her feet on the ground, and to walk the bicycle forward with short steps. The learner is then instructed to walk the bicycle forward using longer steps. The learner is then instructed to push the bicycle forward with the feet and to lift the feet and coast forward on the bicycle as long as vertical balance can be maintained. When the learner can coast with his or her feet off the ground, the learner is then instructed to turn the bicycle left and right while coasting and maintaining vertical balance. Finally, the learner is instructed to push the bicycle forward with the feet, to place the feet on the pedals of the bicycle, and to pedal the bicycle forward while maintaining vertical balance. During all of these learning steps, the learner does not experience fear because he or she can control the bicycle at anytime by placing his or her feet on the ground.

An advantage of the present invention is a teaching method which allows a learner to obtain skill in balancing a moving and turning bicycle without fear of injury or loss of control.

Another advantage is a teaching method which allows the learner to learn how to ride a bicycle at his or her own rate.

Another advantage is a teaching method which eliminates the risk of injury to a learner in the process of acquiring balancing skills on a moving and turning bicycle.

Another advantage is a teaching method that gradually increases the level of balancing skill required to maintain a moving and turning bicycle in a vertical orientation.

Another advantage is a teaching method which provides a means for the learner to control the vertical orientation of a moving and turning bicycle during periods of loss of balance, by the learner using his or her own feet.

### BRIEF DESCRIPTION OF THE DRAWING

FIG. 1 illustrates a training bicycle suitable for the method of the present invention, showing the elements of the pedal crank drive assembly.

### DETAILED DESCRIPTION OF THE INVENTION

While the following description details the preferred embodiments of the present invention, it is to be understood that invention is not limited in its application to the details of construction and arrangement of the parts illustrated in the accompanying drawings, since the invention is capable of other embodiments and of being practiced in various ways.

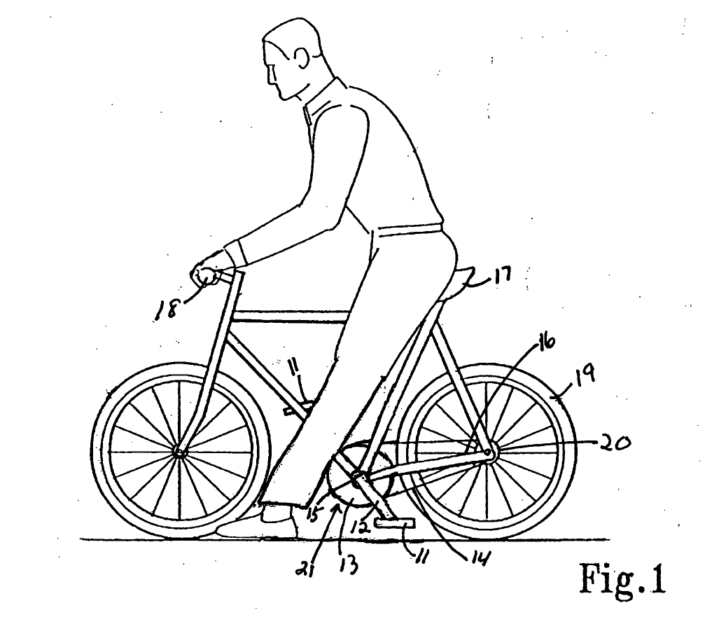

In a preferred embodiment of the present invention a bicycle 10 is provided, an example of which is shown in FIG. 1. The elements of the pedal crank drive assembly 21 of bicycle 10 include the pedal crank 12, pedals 11, and a pedal crank drive sprocket 13. In the initial steps of instructing the learner to ride bicycle 10, the bicycle 10 has the pedals 11, pedal crank 12, pedal crank drive sprocket 13, and drive chain 14 removed, and the empty pedal crank housing 15 is covered with caps (not shown). A bicycle thus prepared allows the maximum freedom of use of the learner's legs and feet in the initial stages of learning to balance a moving bicycle. However, the method can also be implemented with less ease and comfort using an intact bicycle with the pedal crank drive assembly 21 and drive chain 14 in place. In any case, the bicycle 10 and seat 17 height are such that the learner can easily control the vertical orientation of the bicycle 10 with his or her feet on the ground while sitting on the bicycle seat 17. Thus, as the learner sits on the bicycle 10 with his or her hands on the handle bars 18, in the normal usual mode of one preparing to ride a bicycle in its usual vertical orientation, his or her feet will comfortably touch the ground. Because the learner's feet are on the ground, the learner has complete control of the vertical orientation of the bicycle 10. This level of control essentially eliminates any fear that the learner would have of falling over or potentially losing control of the bicycle 10.

In the next step the learner is instructed to walk the bicycle forward. The learner can use short steps at first and then gradually use longer steps. This can be performed without any fear of falling over or losing control because the learner can make contact with the ground using his or her feet at any time to maintain the vertical orientation of the bicycle. However, in the process of walking the bicycle forward the learner is acquiring the beginning elements of balancing the bicycle in the vertical orientation.

In the next step the learner is instructed to push the bicycle forward with the feet and coast forward while lifting the feet off the ground. When the learner is ready to do this the learner will have gained enough balance from the walking process to maintain the bicycle in a vertical orientation by balance alone while coasting. Again, this step can be performed without fear because the learner knows that he or she can begin walking the bicycle or stopping the bicycle at any time by placing his or her feet on the ground. The learner can maintain the coasting of the bicycle as long as he or she can maintain vertical orientation of the bicycle by balance. After the learner has acquired the ability to push the bicycle forward and coast, the learner is then instructed to turn the bicycle to the right and/or left and steer the bicycle in semicircles while coasting.

In the next step the caps are removed from the empty pedal crank housing 15 and the pedal crank 12 with its pedals 11 and drive sprocket 13 are installed. The chain 14 may not be installed at this point. The learner is then instructed to push the bicycle forward with the feet and place the feet on the pedals 11 while coasting. The learner can then be instructed to turn the pedals 11 while coasting. When the chain 14 is not installed the learner can focus on the pedaling motion without having to worry about the acceleration of the bicycle that would occur if the chain 14 was installed. When the learner is comfortable with pedaling forward and backward while coasting forward, the chain 14 can be installed. The learner can then push off with his or her feet, coast forward, and maintain coasting by pedaling forward, or slowing the bicycle by pedaling backward to activate the brake mechanism 16 by methods well known in the art. Alternatively, hand brakes may be used, or both foot and hand brakes may be used.

At this point the learner will have acquired most of the balancing skills necessary to ride a bicycle. Remaining skills such as moving the bicycle forward by pushing the pedals 11 instead of pushing from the ground, or getting on or off the bicycle seat 17 while the bicycle is coasting will come naturally and without fear with continued riding of the bicycle.

Although in one embodiment of the present invention learning to ride a bicycle begins with a learner using a bicycle with an empty pedal crank housing, other variations are possible. For example, a learner may begin learning to ride the bicycle with a pedal crank drive assembly in the pedal crank housing with no drive chain. Alternatively, a learner may begin learning to ride the bicycle with a pedal crank drive assembly in the pedal crank housing with a drive chain attached.

The method of the present invention may be facilitated by providing a kit to the learner which contains a bicycle 10 with an empty pedal crank housing 15, caps to cover the openings of the empty crank housing, a pedal crank drive assembly 21 having a pedal crank 12, pedals 11, and a pedal crank drive sprocket 13, a chain 14 having a master link with clip for opening and closing the chain around the pedal crank drive sprocket 13 and the rear wheel drive sprocket 20, written, audio, and/or video instructions on how to install and remove these components of the pedal crank drive assembly 21 and drive chain 14, and the tools necessary for the installation and removal of these components. The bicycle 10 will have a height-adjustable seat 17 and hand or foot brakes 16 well known in the art. The kit can also have written, audio, and/or video instructions to teach a learner the method of the present invention for riding a bicycle.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, the bicycle seat may be elevated so that only one of the learner's feet can touch the ground with the bicycle at a slightly less than vertical orientation, after the learner has learned to coast the bicycle with the seat in the position where both feet can touch the ground. The caps covering the openings of the empty pedal crank housing can be constructed in any form desired, so as to engage the inner surfaces or outer surfaces, or combination thereof, of the empty pedal crank housing.

It will be understood that various changes in the details, materials, and arrangements of the parts which have been described and illustrated above in order to explain the nature of this invention may be made by those skilled in the art without departing from the principle and scope of the invention as recited in the following claims.

I claim:

1. A teaching method for riding a bicycle comprising:
1) providing a bicycle with an empty pedal crank housing;
2) instructing a learner to sit on said bicycle with said learner's feet on the ground;
3) instructing said learner to walk said bicycle forward;
4) instructing said learner to push said bicycle forward with said learner's feet and to lift the feet while said bicycle coasts forward; and
5) instructing said learner to turn said bicycle as said bicycle coasts forward.

2. The teaching method of claim 1, further comprising the steps of:
6) installing a pedal crank drive assembly without a drive chain in said empty pedal crank housing; and
7) instructing said learner to push said bicycle forward with said learner's feet, to place the feet on pedals of said pedal crank drive assembly while said bicycle is coasting forward, and to pedal said pedal crank drive assembly.

3. The teaching method of claim 2 wherein step 6 includes installing a drive chain so that pedaling said pedal crank drive assembly will drive said bicycle forward.

4. A teaching method for riding a bicycle comprising:
1) providing a bicycle with an empty pedal crank housing;
2) instructing a learner to sit on said bicycle with said learner's feet on the ground;
3) instructing said learner to walk said bicycle forward;
4) instructing said learner to push said bicycle forward with said learner's feet and to lift the feet while said bicycle coasts forward;
5) instructing said learner to turn said bicycle as said bicycle coasts forward;
6) installing a pedal crank drive assembly without a drive chain in said empty pedal crank housing; and
7) instructing said learner to push said bicycle forward with said learner's feet, to place the feet on pedals of said pedal crank drive assembly while said bicycle is coasting forward, and to pedal said pedal crank drive assembly.

5. The teaching method of claim 4 wherein step 6 includes installing a drive chain so that pedaling said pedal crank drive assembly will drive said bicycle forward.

6. A teaching method for riding a bicycle comprising:
1) providing a bicycle with an empty pedal crank housing;
2) instructing a learner to sit on said bicycle with said learner's feet on the ground;
3) instructing said learner to walk said bicycle forward;
4) instructing said learner to push said bicycle forward with said learner's feet and to lift the feet while said bicycle coasts forward;
5) instructing said learner to turn said bicycle as said bicycle coasts forward;
6) installing a pedal crank drive assembly with a drive chain in said empty pedal crank housing; and
7) instructing said learner to push said bicycle forward with said learner's feet, to place the feet on pedals of said pedal crank drive assembly while said bicycle is coasting forward, and to pedal said pedal crank drive assembly to drive said bicycle forward.

7. A teaching method for riding a bicycle comprising:
1) instructing a learner to sit on said bicycle with said learner's feet on the ground, said bicycle having a pedal crank drive assembly and a drive chain;
2) instructing said learner to walk said bicycle forward;
3) instructing said learner to push said bicycle forward with said learner's feet and to lift the feet while said bicycle coasts forward; and
4) instructing said learner to turn said bicycle as said bicycle coasts forward.

8. The teaching method of claim 7, further comprising the step of:
5) instructing said learner to place the feet on pedals of said pedal crank drive assembly while said bicycle is coasting forward, and to pedal said pedal crank drive assembly to move said bicycle forward.

9. A teaching method for riding a bicycle comprising:
1) instructing a learner to sit on said bicycle with said learner's feet on the ground, said bicycle having a pedal crank drive assembly and a drive chain;
2) instructing said learner to walk said bicycle forward;
3) instructing said learner to push said bicycle forward with said learner's feet and to lift the feet while said bicycle coasts forward;
4) instructing said learner to turn said bicycle as said bicycle coasts forward; and
5) instructing said learner to place the feet on pedals of said pedal crank drive assembly while said bicycle is coasting forward, and to pedal said pedal crank drive assembly to move said bicycle forward.

10. A kit for teaching the method of claim 6 for riding a bicycle, comprising:
a) a bicycle with an empty pedal crank housing;
b) caps to cover openings in said empty pedal crank housing;
c) a pedal crank drive assembly having a pedal crank, pedals, and a pedal crank drive sprocket;
d) a drive chain having a master link with clip for opening and closing said drive chain around said pedal crank drive sprocket and around a rear wheel drive sprocket;
e) written, audio, and/or video instructions on how to install and remove the components of said pedal crank drive assembly in said pedal crank housing, and how to install and remove said drive chain; and
f) written, audio, and/or video instructions on how to teach a learner the method of claim 6 for riding a bicycle.

11. The kit of claim 10, further comprising tools for installation and removal of said pedal crank drive assembly and drive chain.

12. A kit for teaching the method of claim 9 for riding a bicycle, comprising:
a) a bicycle with an empty pedal crank housing;
b) caps to cover openings in said empty pedal crank housing;
c) a pedal crank drive assembly having a pedal crank, pedals, and a pedal crank drive sprocket;
d) a drive chain having a master link with clip for opening and closing said drive chain around said pedal crank drive sprocket and around a rear wheel drive sprocket;
e) written, audio, and/or video instructions on how to install and remove the components of said pedal crank drive assembly in said pedal crank housing, and how to install and remove said drive chain; and
f) written, audio, and/or video instructions on how to teach a learner the method of claim 9 for riding a bicycle.

13. The kit of claim 12, further comprising tools for installation and removal of said pedal crank drive assembly and drive chain.
